(19) United States
(12) Patent Application Publication
(10) Pub. No.: US 2004/0242717 A1
(43) Pub. Date: Dec. 2, 2004

(54) Acoustically absorbant foam with elastic properties

(76) Inventor: Simon Pakenham McNeale Beatty, Brisbane (AU)

Correspondence Address: Martin A. Hay, 13 Queen Victoria Street, Macclesfield Cheshire UK, SK11 6LP, GB

(21) Appl. No.: 10/485,822

(22) PCT Filed: Aug. 16, 2002
(86) PCT No.: PCT/GB02/03799

(30) Foreign Application Priority Data
Aug. 18, 2001 (GB) 0120200.1

(51) Int. Cl. C08G 18/00

(52) U.S. Cl. 521/155

(57) ABSTRACT

The invention relates to a method of providing a surface of an object with a sound insulatory coating by forming an elastic open-celled polyurethane foam by spraying foam forming mixture onto the surface, and to an acoustic spray polyurethane foam.

A variety of foams are commercially available for domestic and industrial applications which are designed to be sprayed on to, and adhere to, a surface so as to provide heat insulatory benefits. Derivations of these foams can be moulded, injected or produced as slabs.

The composition of a common rigid polyurethane foam of such a type consists of a spraying designated polymer and a liquid isocyanate mixed together in the volume ratio 1:1. The foam is formed utilising a spray system which independently pressurises each of the said components, heats them, and atomises them in the said ratio at which point the foam is formed as it is applied to a surface.

One of the characteristics of such a foam is its high degree of hardness, a consequence of this being that whilst it offers heat insulatory benefits its usefulness as a sound insulator is minimal due to its high rigidity.

It is an object of the present invention to provide an improved foam which may be applied using a spray system and which has a degree of elasticity which endows it with both heat insulatory and sound insulatory (i.e. sound absorption) benefits.

A foam having these desirable characteristics has now been found that is composed of a spraying designated polymer, to which additional water has been added, and a liquid isocyanate (or isocyanurate) wherein the ratio of spraying designated polymer to isocyanate is 3000:1000. The formation of the foam is achieved using the contemporary technique of independently pressuring each of the said components, heating them, and then atomising them. The water having being mixed previously with the polymer and the two components (polymer and isocyanate) when mixed as described form the foam which may be applied.

Such a foam has a degree of elasticity not offered by existing foams applied using spray systems and as such offers excellent sound insulatory benefits due to its increased capacity to resonate to ambient sounds. Tests show that it can be also moulded or injected using the appropriate means.

The ability of such a foam to adhere to a surface, and its elasticity and thereby effectiveness as a sound insulator, is largely dependent on both the proportions of the aforementioned constituents and the temperature to which they are raised during formation of the foam. As such the proportion of the constituents may be varied to achieve optimum performance.

The polyurethane foam formed by the process according to the invention is an elastic open-celled polyurethane foam.

It is believed to be novel to spray an elastic open-celled polyurethane foam onto surface of an object to provide sound insulation.

According to one aspect, therefore, the present invention provides a method of providing a surface of an object with a sound insulatory coating, which comprises forming an elastic open-celled polyurethane foam by spraying foam forming mixture onto the surface.

By “open-celled” foam, is meant a foam having at least 70% open cells, preferably at least 80%, more preferably at least 85%.

The surface may be, for example, steel, timber, brick, slate, tile, metal, concrete glass, asphalt (bitumen), roofing felt or asbestos. It may also be the foamed component formed within a skin as for example as the foamed component in wall- or insulation-boards and refrigerators. It may also be a rigid polyurethane spray foam which may have been applied, for example, to provide heat insulation.

The object may be any object on which an acoustic barrier is desired, for example a wall or roof of a domestic, industrial, commercial or agricultural building. It may also be a fence, for example alongside a source of noise pollution such as a road, railway or airport. The foam of the invention may be used as a sound absorption barrier in cavities, floors including suspended floors, factory walls, roofing, acoustic hoods, engine housings, aircraft, ships and vehicles.

Flexible open-celled polyurethane foams may be formed from a spraying designated polymer to which additional water has been added and liquid isocyanate, in which the ratio of spraying designated polymer/water mixture to liquid isocyanate is in the range of from 2.5:1 to 4:1.

Those skilled in the art of making polyurethane foams will understand that the term “spraying designated polymer” as used herein refers to a pre-mix used to prepare conventional rigid foams. Such a premix generally contains one or more polyols, the free hydroxyl groups of which react with the isocyanate to afford the polyurethane; one or more blowing agents, to form the polyurethane as a foam; and any other additives, such as a catalyst and stabiliser. The one or more blowing agents generally include water. Thus manufacturers of spraying designated polymers for use in spraying rigid foams will understand from this patent specification that by adding more water to their spraying designated polymers and by altering the ratio of spraying designated polymer/water mixture to liquid isocyanate, then flexible open-celled foams having sound insulatory properties may be obtained.

The spraying designated polymer may be, for example, any commercially available product that is used in the spraying of rigid polyurethane foams onto surfaces to provide heat insulation.

The volume ratio of spraying designated polymer/water mixture to liquid isocyanate is preferably in the range of from 2.7:1 to 3.8:1, more preferably in the range of from 2.9:1 to 3.1:1. For example it is about 3:1.

Preferably the weight of water in the designated spraying polymer/water mixture is in the range of from 10 to 20%, more preferably in the range of from 13 to 18%, such as in the range of from 14 to 16%. For example, the weight of water in the designated polymer/water mixture is about 15.7%.

The one or more blowing agents may be selected from blowing agents conventionally used in the formation of polyurethane foam sprays, for example chlorofluorocarbons, such as 1,2-dichloro-1-fluorethane. Other blowing agents include water, fluorocarbons, alkanes such as pentane, cycloalkanes such as cyclopentane, and acetals.

The isocyanate may be any one or more isocyanates conventionally used in the formation of polyurethane foam sprays. Examples of isocyanates include polymeric diphenylmethane diisocyanate. Examples of isocyanates used in the production of polyurethane foams are described in U.S. Pat. No. 6,316,514.

The polyol may again be any polyol conventionally used in the formation of rigid polyurethane foam sprays. Examples of polyols include polyether polyols formed by polymerising alkylene oxides; polyesterester polyols and polyamine polyols. Examples of polyols used in the production of polyurethane foams are described in U.S. Pat. No. 6,316,514.

The spraying designated polymer may further comprise one or more catalysts. The one or more catalysts may be selected from catalysts conventionally used in the production of polyurethane foams. Examples include tertiary amines such as triethylenediamine, dimethylethanolamine, N-methylmorpholine, N-ethylmorpholine, diethylethanolamine, and organometallic reagents such as dibutyltin dilaurate. Further examples of catalysts are described in U.S. Pat. No. 6,316,514. An additional quantity of catalyst may be used to increase the rate of polyurethane foam production at low ambient temperature, for example, during winter.

The spraying designated polymer may further comprises a flame retardant. Compounds suitable for use as flame retardants are well known in the polyurethane foam art. An example of a flame retardant is tris(2-chloroisopropyl)phosphate. Other examples are described in U.S. Pat. No. 6,316,514.

The spraying designated polymer further comprises a surfactant. Again, compounds suitable for use as surfactants are well known in the polyurethane foam art. An example of a surfactant is a silicone based surfactant.

The foam may be applied using a conventional polyurethane spray gun equipped with an inlet port for the sprayable designated polymer/water mix and an inlet port for the liquid isocyanate. The pump is set so that the ratio of sprayable designated polymer/water mix to liquid isocyanate is about 3:1. Prior to being fed to the pump, each component is separately pressurised and heated to a temperature in the range of from 30° C. to 50° C., preferably from 35° C. to 45° C. The foam is preferably formed from the gun in passes, preferably 1 or 2 passes, each pass depositing liquid to provide a foam having a depth of not less than 10 mm. The depth of foam required to provide an effective acoustic barrier is conveniently in the range of from 10 to 75 mm, preferably from 20 to 50 mm.

Foam applied in accordance with the invention preferably has a sound coefficient as measured for a foam depth of 20 mm at 500 Hz of at least 0.2, preferably at least 0.45.

After the foam has been provided to a surface, it may if desired, be painted.

According to another aspect, the present invention provides a flexible open-celled polyurethane foam, obtainable by spraying a mixture of a spraying designated polymer and added water with liquid isocyanate in which the volume ratio of spraying designated polymer to liquid isocyanate is in the range of from 2.5:1 to 4:1 and percentage by weight of water in the spraying designated polymer/water mixture is in the range of from 10 to 20%.

In addition to being formed by spraying, the foam may be formed by pouring foam forming mixture into a mould and then allowing it to foam.

According to yet another aspect, the present invention provides a kit of parts for use with a polyurethane spray gun to apply an acoustic foam to the surface of an object, which comprises a first vessel containing a spraying designated polymer/water mixture, wherein the percentage by weight of water in the spraying designated polymer/water mixture is in the range of from 10 to 20%; and a second vessel containing liquid isocyanate, together with instructions to spray the spraying designated polymer/water mixture and the liquid isocyanate in a ratio of from 2.5:1 to 4:1.

According to a still further aspect, the present invention provides the use of a polyurethane spray gun to apply a flexible open-celled polyurethane foam to a surface of an object to provide noise insulation.

The following example illustrates the invention.

### EXAMPLE 1

| Spraying designated polymer | |
|---|---|
| Polyol 7030EP ™ | 54.5% |
| Lupranol 3903 ™ | 8.5% |
| 1,1-Dichloro-1-fluoroethane | 21.6% |
| Tris(2-chloroisopropyl)phosphate | 11.4% |
| Dabco DMEA ™ | 1.3% |
| Dabco DC-198 ™ | 0.8% |
| Dabco T12-N ™ | 1.3% |
| Water | 0.6% |
| Additional Water | 100% |
| Liquid Isocyanate | |
| Lupranat M20S ™ | 100% |

Polyol 7030EP™ is a condensate polyol produced from nonyl phenol and diethanolamine blended 70/30 with tris(2-chloroisopropyl)phosphate. It is obtainable from Abbey Thermsets Ltd, Whitelands Mill, Whitelands Road, Ashton under Lyne, OL6 6UG, United Kingdom. It has a typical OH value of 400/440.

Lupranol 3903™ is a trifunctional polyether polyol. It has an OH number of 935 mg/KOH/g. It is obtainable from BASF Elastogran U.K. Ltd., Alfreton Trading Estate, Wimsey Way, Somercotes, Alfreton, Derbyshire DE55 4NL, United Kingdom.

Dabco DMEA™ is a dimethylethanolamine catalyst obtainable from Air Products and Chemicals, Inc, Performance Chemicals Division, Box 538, Allentown Pa. 18105-1501, United States.

Dabco DC-198 is a silicone glycol copolymer. It is obtainable from Air Products and Chemicals, Inc, Polyurethane Chemicals Division, 7201 Hamilton Boulevard, Allentown Pa. 18195-1501, United States.

Dabco T12-N™ is a liquid formulation of dibutyltin dilaurate. It is obtainable from Air Products and Chemicals, Inc, Polyurethane Chemicals Division, 7201 Hamilton Boulevard, Allentown Pa. 18195-1501, United States.

Lupranat M20S™ is a polymeric MDI (4,4′-diphenylmethane diisocyanate) containing oligomers of high functionality and isomers. The average functionality is 2.7. It has an NCO content of 31.3 g/100 g. It is also obtainable from BASF Elastogran U.K. Ltd.

The Polyol 7030EP™ is pre-mixed with the 1,1-dichloro-1-fluoroethane using a high speed mixer in a suitable container. The premix is then transferred to a larger blending vessel by suction pump. Each of the remaining ingredients of the spraying designated polymer excluding the water are then transferred to the blending vessel by suction pump. The total amount of water is then transferred to the blending vessel. The total amount of water in the combined spraying designated polymer/water mix is 15.7% by weight. Thus the ratio of spraying designated polymer:water is 1000 to 178. The combined ingredients are then paddle mixed at ambient temperature for at least one hour.

The mixture of spraying designated polymer and water, and the liquid isocyanate, are each separately pressurised and heated to a temperature of 43° C. They are then pumped into a polyurethane spray gun, with the pump ratio of 3000:1000 spraying designated polymer/water to liquid isocyanate. The mixture is then sprayed onto a surface in a single pass to form a depth of about 20 mm.

Properties of Foam

| | |
|---|---|
| Sound absorption coefficient (20 mm depth) @ 500 hz | 0.55 |
| Open Cell Content | 86% |
| Thermal Conductivity | 0.033 W/Mk |
| Core density | 30 kg/m³ |
| Compressive strength (parallel to rise) | 100 Kpa |
| Tensile strength (perpendicular to rise) | 140 Kpa |
| Shear strength (perpendicular to rise) | 80 Kpa |
| Dimensional stability (7 days @ 100° C.) | <1% |

### COMPARATIVE EXAMPLE

The steps of Example 1 are repeated, but omitting the additional water and pumping the spraying designated polymer and liquid isocyanate into the spray gun in the ratio of 1:1.

Properties of Foam

| | |
|---|---|
| Sound absorption coefficient (20 mm depth) @ 500 hz | 0.11 |
| Closed Cell Content | 90% |
| Thermal Conductivity | 0.17 W/Mk |
| Core density | 44-48 kg/m³ |
| Compressive strength (parallel to rise) | 100 Kpa |
| Tensile strength (perpendicular to rise) | 140 Kpa |
| Shear strength (perpendicular to rise) | 80 Kpa |
| Dimensional stability (7 days @ 100° C.) | <1% vol |

1. A method of providing a surface of an object with a sound insulatory coating, which comprises forming an elastic open-celled polyurethane foam by spraying foam forming mixture onto the surface.

2. A method as claimed in claim 1, in which the surface is steel, timber, brick, slate, tile, metal, concrete glass, asphalt (bitumen), roofing felt or asbestos.

3. A method as claimed in claim 1, in which the surface is a rigid polyurethane spray foam.

4. A method as claimed in claim 1, in which the object is a wall or roof of a domestic, industrial, commercial or agricultural building, or a fence.

5. A method as claimed in claim 1, in which said flexible open-celled polyurethane foam is formed from a spraying designated polymer to which additional water has been added and liquid isocyanate, in which the ratio of spraying designated polymer/water mixture to liquid isocyanate is in the range of from 2.5:1 to 4:1.

6. A method as claimed in claim 5, in which the ratio of spraying designated polymer/water mixture to liquid isocyanate is in the range of from 2.7:1 to 3.8:1.

7. A method as claimed in claim 6, in which the ratio of spraying designated polymer/water mixture to liquid isocyanate is in the range of from 2.9:1 to 3.1:1.

8. A method as claimed in claim 5, in which the weight of water in the spraying designated polymer/water mixture is in the range of from 10 to 20%.

9. A method as claimed in claim 8, in which the weight of water in the spraying designated polymer/water mixture is in the range of from 13 to 18%.

10. A method as claimed in claim 9, in which the weight of water in the spraying designated polymer/water mixture is in the range of from 14 to 16%.

11. A method as claimed in claim 10, in which the weight of water in the spraying designated polymer/water mixture is about 15.7%.

12. A method as claimed in claim 5, in which the spraying designated polymer comprises a polyether polyol.

13. A method as claimed in claim 5, in which the isocyanate is a diphenylmethylene diisocyanate.

14. A method as claimed in claim 5, in which the spraying designated polymer further comprises a blowing agent.

15. A method as claimed in claim 14, in which the wing agent is 1,2-dichloro-1-fluorethane.

16. A method as claimed in claim 5, in which the spraying designated polymer further comprises one or more catalysts.

17. A method as claimed in claim 16, in which the one or more catalysts are dimethylethanolamine and dibutyltin dilaurate.

18. A method as claimed in claim 5, in which the spraying designated polymer further comprises a flame retardant.

19. A method as claimed in claim 18, in which the flame retardant is tris(2-chloroisopropyl)phosphate.

20. A method as claimed in claim 5, in which the spraying designated polymer further comprises a surfactant.

21. A method as claimed in claim 20, in which the surfactant is a silicone based surfactant.

22. A method as claimed in claim 5, in which a mixture of the spraying designated polymer and water and the liquid isocyanate are each heated to a temperature in the range of from 30° C. to 50° C., and then sprayed on the surface using a spray gun.

23. A method as claimed in claim 22, in which the mixture of the spraying designated polymer and water and the liquid isocyanate are each heated to a temperature in the range of from 35° C. to 45° C.

24. A method as claimed in claim 1, in which the coating is provided to a depth in the range of from 10 to 75 mm.

25. A method as claimed in claim 1, which further comprises painting the coating.

26. A flexible open-celled polyurethane foam, obtainable by spraying a mixture of a spraying designated polymer and water with a liquid isocyanate in which the volume ratio of designated polymer to liquid isocyanate is in the range of from 2.5:1 to 4:1 and percentage by weight of water in the spraying designated polymer/water mixture is in the range of from 10 to 20%.

27. A kit of parts for use with a polyurethane spray gun to apply an acoustic foam to the surface of an object, which comprises a first vessel containing a spraying designated polymer/water mixture, wherein the percentage by weight of water in the spraying designated polymer/water mixture is in the range of from 10 to 20%; and a second vessel containing a liquid isocyanate, together with instructions to spray the spraying designated polymer/water mixture and the liquid isocyanate in a ratio of from 2.5:1 to 4:1.

28. (canceled):
